(19) United States
(12) Patent Application Publication
(10) Pub. No.: US 2018/0050545 A1
(43) Pub. Date: Feb. 22, 2018

(54) EASY REPLACEMENT OF THERMAL PRINT HEAD AND SIMPLE ADJUSTMENT ON PRINT PRESSURE

(71) Applicant: Datamax-O'Neil Corporation, Orlando, FL (US)

(72) Inventors: Suraini Binte Saptu, Singapore (SG); Noorasykin Binte Mokhtar, Singapore (SG)

(21) Appl. No.: 15/239,118

(22) Filed: Aug. 17, 2016

(51) Int. Cl. B41J 2/335

(52) U.S. Cl. CPC B41J 2/33595; B41J 2/33575

(57) ABSTRACT

Embodiments of the present invention describe a thermal print head (TPH) that is easily replaced in a slot on the side of a thermal printing device using a push/eject mechanism. Other embodiments of the present invention describe a thermal printing device where the print pressure is easily adjusted for different types of printing media (labels) by turning a turnknob. In preferred embodiments, the turnknob has three print pressure settings, high, medium, and low.

### FIELD OF THE INVENTION

Embodiments of the present invention relate to thermal printing devices with thermal print heads and controls for print pressure.

### BACKGROUND

Thermal printing devices are well known in the art. One of the primary applications of thermal printing devices is label making, in which thermal ink is transferred onto a media, like a label, by sending data to the thermal print head (TPH) and then powering/heating the elements of the thermal print head to transfer the desired pattern of thermal ink onto the label.

Thermal print heads are obviously integral to the design of thermal printing devices. They are designed to be accurate, reliable, and relatively secure from tampering, as any disturbance of the thermal print head could affect the print results. As a consequence, thermal print heads are generally not designed for easy maintenance and replacement. For users of thermal printing devices that are not technically inclined, replacing a thermal print head can be time consuming and can require special tools.

For example, FIG. 1 illustrates a typical thermal print head mounting system 100 known in the prior art with a thermal print head 105 attached to a baseplate 101 that includes holes 103 and hooks 104 for mounting the system 100 in a thermal printing device. The thermal print head 105 has a socket-type electrical connector 102 for connection to a complementary plug-type connector (not shown). Such a typical arrangement requires the user of the thermal printing device to take the printing device apart, remove the system 100, disconnect the power cable from the connector 102, replace the thermal print head 105, and reassemble everything. Such a maintenance routine can introduce significant downtime and negative economic impact in industrial printing applications.

Accordingly, there is a need for a thermal printing device with an easily replaceable thermal print head that reduces maintenance downtime.

A further challenge for users of thermal printing devices is printing pressure. Depending upon the type of media (i.e. label) and the type of print job, different pressures are needed to transfer the thermal ink pattern. In an attempt to allow the user to optimize the printing pressure, earlier solutions have provided users with several controls to adjust and tune the printing pressure. For most applications, however, such precision is not required and a reduced set of pressure settings is sufficient for most applications and reduces complexity for the user.

Therefore, there is a need for a thermal printing device with a simple print pressure adjustment control.

### SUMMARY

Accordingly, one aspect of the present invention discloses a thermal printing device comprising: an internal slot having on one end an opening on one side of the housing of the thermal printing device for receiving a thermal print head with contact connector terminals on one short edge of the thermal print head; and a push-activated connector, at the opposite end of the internal slot from the opening, for receiving the thermal print head contact connector terminals.

In other embodiments, the thermal print head is mounted upon the application of pushing pressure.

In further embodiments, the mounted thermal print head is unmounted upon the application of pushing pressure.

In still further embodiments, the push-activated connector for receiving the thermal print head comprises a plurality of receiving connector terminals.

In more embodiments, each of the plurality of receiving connector terminals comprises a receiving terminal contact.

In separate embodiments, each receiving terminal contact is in contact with a corresponding contact connector terminal on the thermal print head when the thermal print head is mounted.

In still additional embodiments, the push-activated connector further comprises a tray for holding the thermal print head.

In additional embodiments, the thermal printing device further comprises a cover for the internal slot.

In expanded embodiments, the cover for the internal slot is selected from the group consisting of: a slider, a cap, and a cover flap.

In another embodiment, the thermal printing device further comprises a print pressure turn-knob.

In yet further embodiments, the print pressure turn-knob has a plurality of discrete print pressure settings, each associated with different print pressures.

In other embodiments, the print pressure turn-knob has three discrete print pressure settings corresponding to low, medium, and high print pressures.

In further embodiments, the thermal printing device further comprises a print pressure mechanism, wherein the print pressure mechanism applies the print pressure along the surface of the thermal print head and the print pressure mechanism is controlled by the print pressure turn-knob.

In still further embodiments, the print pressure mechanism comprises a bracket, a spring, a leave spring, and a detent.

A further aspect of the present invention describes a thermal print head comprising: a circuit board; a plurality of heating resistor elements extending along a first long edge of the circuit board; a plurality of contact connector terminals along one short edge of the circuit board; and a conductor circuit pattern for establishing electrical connection between the plurality of heating resistor elements and plurality of contact connector terminals.

And yet a further aspect of the present invention imparts a method for inserting a thermal print head in a thermal printing device, the method comprising: receiving, by the thermal printing device, a thermal print head into an internal slot via an opening on a side of the housing of the thermal printing device, the slot having a push-activated connector at the end of the slot opposite the opening; and responsive to the application of first pushing pressure on the thermal print head, mounting the thermal print head in the push-activated connector of the thermal printing device.

In more embodiments, the method further comprises: responsive to the application of second pushing pressure on the mounted thermal print head in the thermal printing device, unmounting the thermal print head from the push-activated connector in the thermal printing device; and partially ejecting the thermal print head out of the thermal printing device so that it may easily be removed.

An additional aspect of the present invention describes a thermal printing system comprising: a thermal printing device comprising: an internal slot with an opening on a side of the housing of the thermal printing device; and a push-activated connector at the opposite end of the slot from the opening, wherein the thermal printing device is operable to: receive, in the slot through the opening, a thermal print head with contact connector terminals on one short edge of the thermal print head; and responsive to the application of first pushing pressure on the thermal print head, mounting the thermal print head in the push-activated connector; and a thermal print head comprising: a circuit board; a plurality of heating resistor elements extending along a first long edge of the circuit board; a plurality of contact connector terminals along one short edge of the circuit board; and a conductor circuit pattern for establishing electrical connection between the plurality of heating resistor elements and plurality of contact connector terminals.

In still additional embodiments, the thermal printing device is further operable to: responsive to the application of second pushing pressure on the mounted thermal print head in the thermal printing device, unmount the thermal print head from the push-activated connector in the thermal printing device; and partially eject the thermal print head out of the thermal printing device so that it may easily be removed.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 is a diagram of a typical thermal print head mounting system known in the prior art.

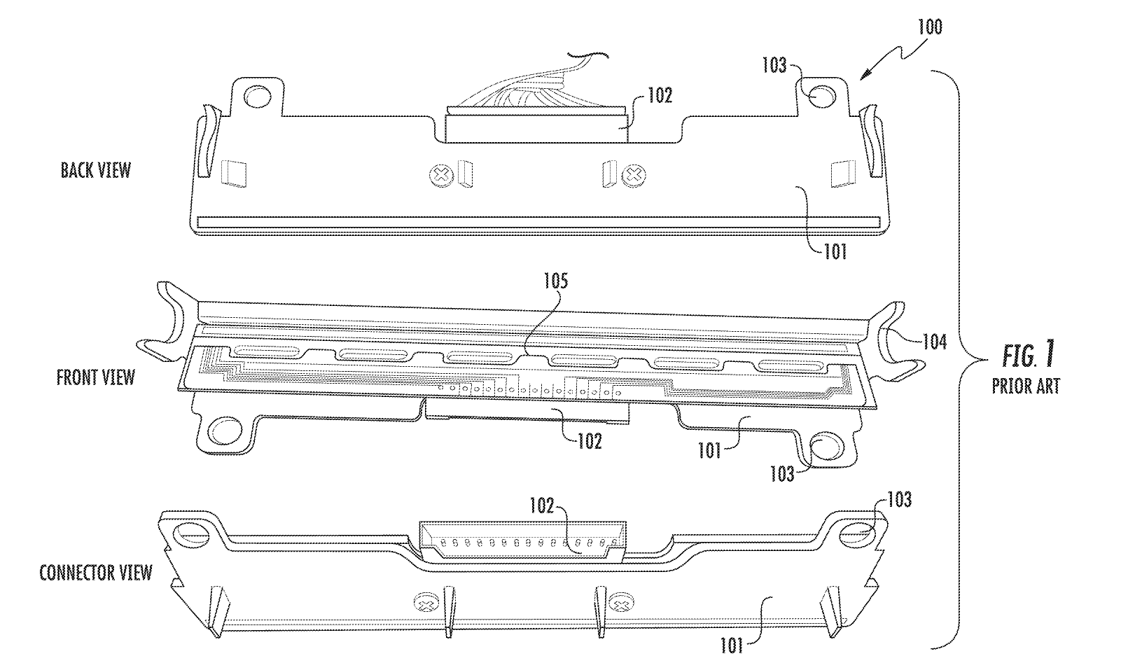

FIGS. 2A and 2B are diagrams of a thermal printing device in accordance with embodiments of the present invention.

FIGS. 2C and 2D are diagrams of a print pressure turn-knob for a thermal printing device in accordance with embodiments of the present invention.

FIG. 3 is a diagram of a thermal print head according to embodiments of the present invention.

FIG. 4 is a diagram that illustrates a push-activated connector for a thermal print head in a thermal printing device according to embodiments of the present invention.

FIG. 5 is a diagram of the print pressure mechanism for a thermal print head in a thermal printing device according to embodiments of the present invention.

FIG. 6 is a diagram that illustrates the replacement of the thermal print head in a thermal printing device according to embodiments of the present invention.

### DETAILED DESCRIPTION

Embodiments of the present invention relate a thermal printing device with an easily replaceable thermal print head that reduces maintenance downtime. Embodiments of the present invention also relate to a thermal printing device with a simple print pressure adjustment control.

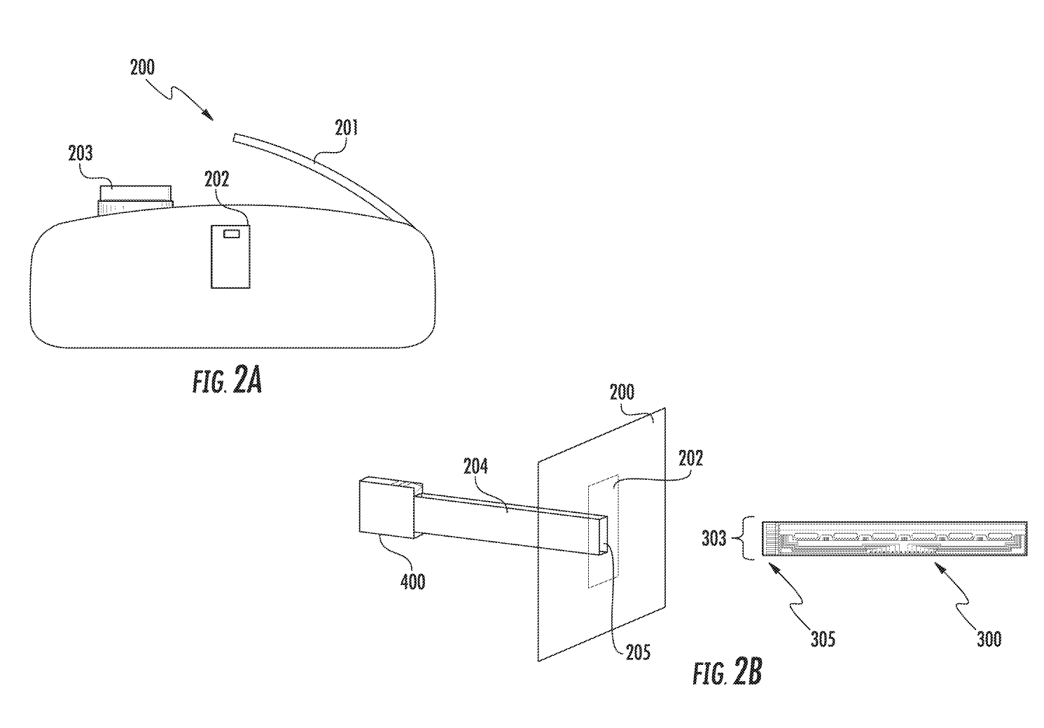

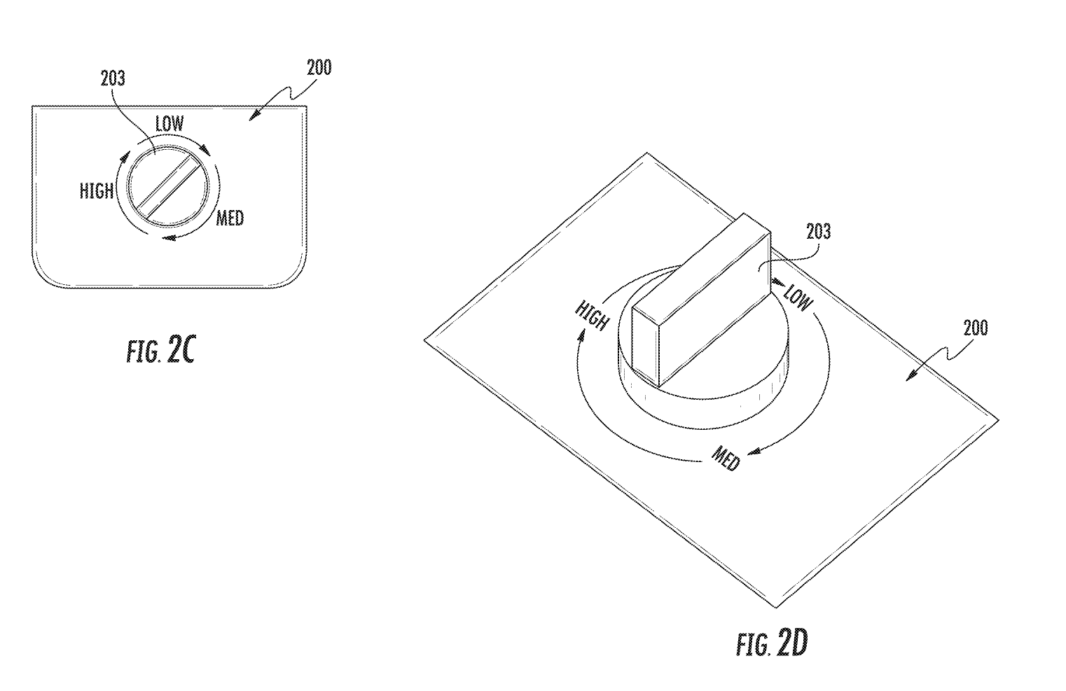

FIG. 2A is a diagram of a thermal printing device in accordance with embodiments of the present invention. The thermal printing device 200 has a door 201, a thermal print head cover 202, and a print pressure turn-knob 203. As shown in FIG. 2B, a thermal print head 300 with a power/data connector 305 comprising contact connector terminals 303 is inserted into the push-activated connector 400 via a slot 204 through an opening 205 behind the thermal print head cover 202 on the side of the housing of thermal printing device 200. While shown with a vertical orientation in FIGS. 2A and 2B, in other embodiments, the thermal print head 300 may be inserted into the thermal printing device 200 along any orientation (horizontal, diagonal, specific angle relative to an identified axis, etc.) that may be appropriate for different designs of thermal printing devices 200.

Under the door 201, the thermal printing device 200 includes a roll of thermal ink, such as a ribbon roll, and a roll of media, such as a roll of labels (both not shown in FIG. 2A). The thermal printing device 200 works by heating the thermal print head to fuse a pattern of thermal ink from the ribbon roll to the label.

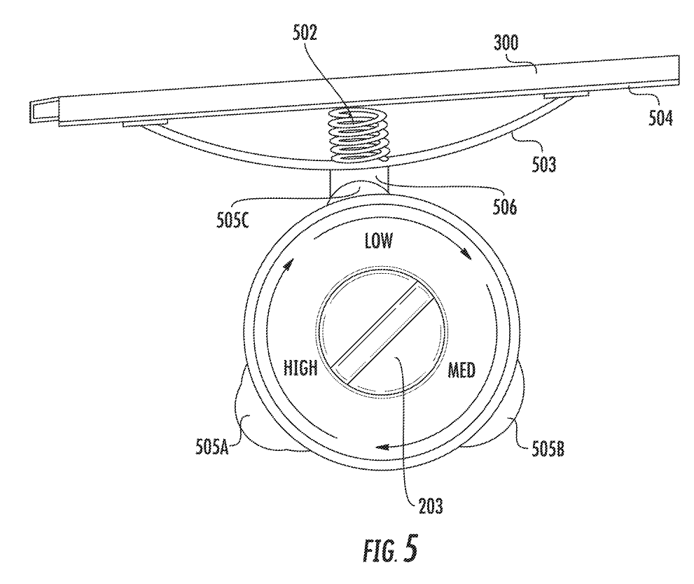

It should be noted that while slot 204 is shown as a closed slot in FIG. 2B, in practice, one surface of the thermal print head is exposed to the ribbon and label of the thermal printing device in order to effect printing. Additionally, as discussed below, the opposite surface of the thermal print head is subject to a print pressure mechanism (as outlined in FIG. 5) in order to regulate the print pressure during printing. Therefore, the slot 204 is meant to represent slots, grooves, guides or any of a number of mechanisms to guide the thermal print head 300 into the push-activated connector 400 in the thermal printing device 200.

FIG. 2C and 2D are diagrams of a print pressure turn-knob for a thermal printing device in accordance with embodiments of the present invention. FIG. 2C is a top view of the print pressure turn-knob 203, and FIG. 2D is a perspective/profile view of the print pressure turn-knob 203. In one embodiment, the print pressure turn-knob 203 has three discrete positions (high, medium, and low), each associated with a corresponding distinct print pressure setting (high, medium, and low). The print pressure settings correspond to a distinct amount of force applied by a spring mechanism (discussed in FIG. 5 below) to the thermal print head 300 in the thermal printing device 200.

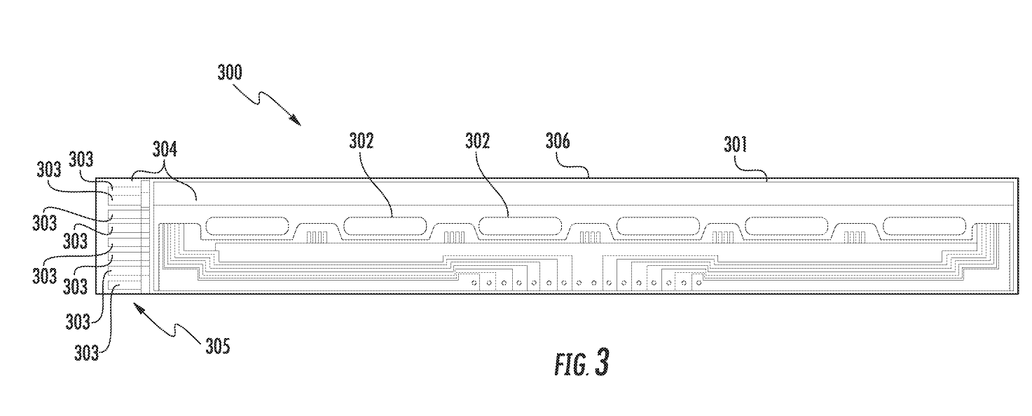

FIG. 3 is a diagram of a thermal print head according to embodiments of the present invention. The thermal print head 300 is comprised of a circuit board 306, a plurality of heating resistor elements 301 along one long edge of the circuit board, a power/data connector 305 comprised of a plurality of contact connector terminals 303 along one short edge of the circuit board, and a conductor circuit pattern 304 for connecting the various circuit elements. The thermal print head 300 may further comprise other elements, such as protective resin body, for enclosing circuit elements on the thermal print head 300. In some embodiments, the thermal print head 300 is comprised of a strip-like circuit board 306 with two long edges and two short edges. In other embodiments, the contact connector terminals 303 may appear only on one short edge of the thermal print head 300. In yet other embodiments, the thermal print head 300 may have a plurality of integrated circuits 302 along one edge of the circuit board 306.

It should be noted that in other embodiments, the electrical components of the thermal print head 300 (the contact connector terminals 303, plurality of heating resistor elements 301, integrated circuits 302, conductor circuit pattern 304, etc.) may take on any layout, orientation, and configuration on the circuit board 306 as necessary to meet the design of specific thermal printing devices 200 and to effect the easy replacement of the thermal print head 300 in those thermal printing devices 200.

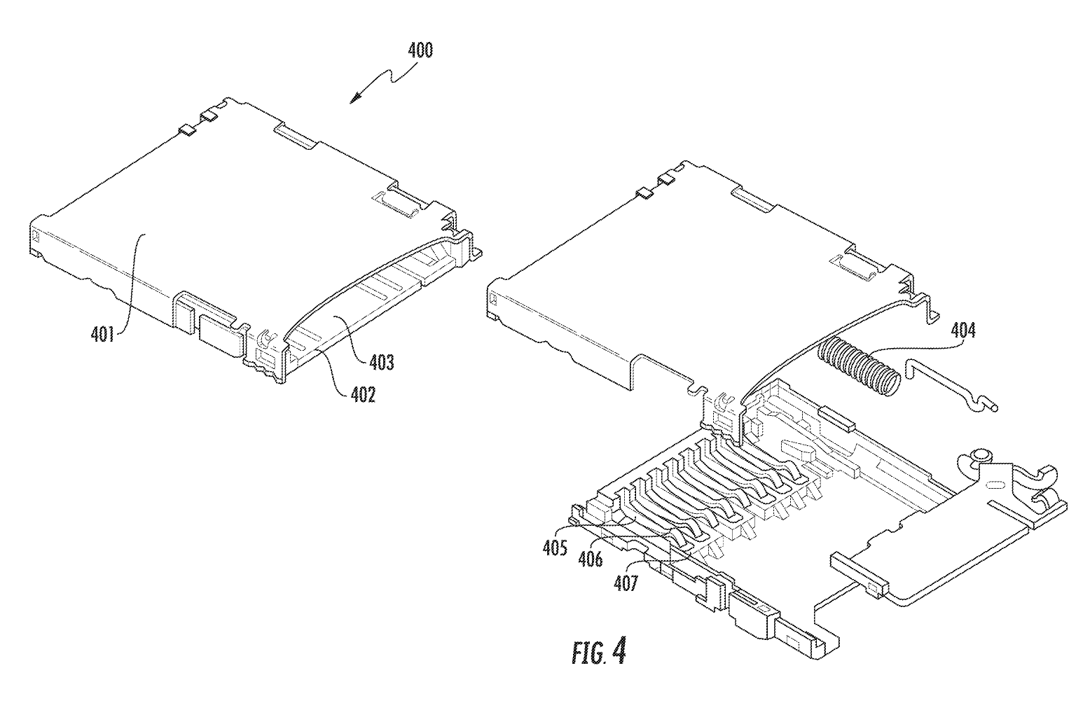

FIG. 4 is a diagram that illustrates a push-activated connector according to embodiments of the present invention. The push-activated connector 400 is comprised of a top 401 and bottom 402 and a push-activated connector opening 403 for receiving a strip-like thermal print head 300. The push-activated connector 400 further comprises a spring 404, receiving connector terminals 405, receiving terminal contacts 406, and receiving terminal grooves 407.

In other embodiments, the push-activated connector 400 comprises a tray for holding the thermal print head 300 in position for better precision of the insertion of the thermal print head 300 into the push-activated connector opening 403 of the push-activated connector 400.

The push-activated connector 400 that receives the thermal print head 300 is positioned in the thermal printing device 200 at the end of the slot 204 opposite the opening 205 and the thermal print head cover 202.

FIG. 5 is a diagram of the print pressure mechanism according to embodiments of the present invention. Specifically, FIG. 5 shows the top view of the print pressure mechanism. As shown in FIG. 5, the print pressure turn-knob 203 is connected to the end of a rod or boss (not visible in the top view of FIG. 5) comprising three cams (505A, 505B, and 505C). Each of the cams correspond to a different print pressure setting, i.e. cam 505A corresponds to a high print pressure setting, cam 505B corresponds to a medium print pressure setting and cam 505C corresponds to a low print pressure setting. As the print pressure turn-knob 203 is rotated to the different print pressure settings, the cams (505A, 505B, 505C) catch on detent 506 and exert a discrete pressure against the spring 502 and the leave spring 503 connected to bracket 504. The spring 502 and the leave spring 503 with bracket 504 work together to evenly distribute the pressure along the surface of the thermal print head 300 to provide a consisting print pressure. In other embodiments where the orientation of the thermal print head 300 is not vertical (as shown in FIGS. 2A and 2B), additional mechanisms may be part of the print pressure mechanism to effect the same result described herein.

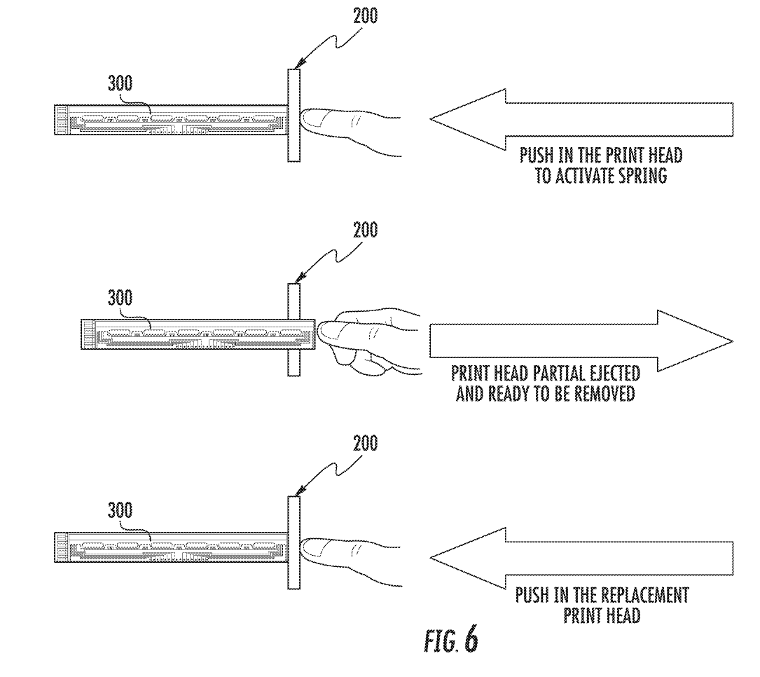

FIG. 6 is a diagram that illustrates the replacement of the thermal print head in a thermal printing device according to embodiments of the present invention.

In the replacement of the thermal print head 300, the thermal print head cover 202 (not shown in FIG. 6) is first removed. This may be done in a variety of ways according to different embodiments. In one embodiment, the thermal print head cover 202 is a slider that is pushed to one side to reveal the slot for the thermal print head 300 in the thermal printing device 200. In another embodiment, the thermal print head cover 202 may be completely removed from the thermal printing device 200 (like a cap) to reveal the slot for the thermal print head 300. In still other embodiments, the thermal print cover 202 may be tethered to the thermal printing device 200 (like a cover flap) and just pushed out of the way to reveal the slot for the thermal print head 300. Once the thermal print head cover 202 is removed from obstructing the slot, the thermal print head 300 is inserted lengthwise into the slot and the push-activated connector 400 at the far end of the slot.

Upon insertion of the thermal print head 300 into the push-activated connector 400, each contact connector terminal 303 of the power/data connector 305 on the thermal print head 300 contacts the corresponding receiving terminal contacts 406 and depresses the receiving connector terminals 405 in the receiving terminal grooves 407. The thermal print head 300 is mounted or locked in position.

Upon the further application of pushing pressure on the thermal print head 300, the thermal print head 300 is unmounted or released from the locked position and the spring 404 of the push-activated connector 400 nudges, pushes, or ejects the thermal print head 300 out of the push-activated connector 400 slightly or partially so that it may be completely removed.

The disclosed subject matter may be embodied as devices, systems, methods.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER′S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A thermal printing device comprising:
an internal slot having on one end an opening on one side of the housing of the thermal printing device for receiving a thermal print head with contact connector terminals on one short edge of the thermal print head; and
a push-activated connector, at the opposite end of the internal slot from the opening, for receiving the thermal print head contact connector terminals.

2. The thermal printing device of claim 1, wherein the thermal print head is mounted upon the application of pushing pressure.

3. The thermal printing device of claim 2, wherein the mounted thermal print head is unmounted upon the application of pushing pressure.

4. The thermal printing device of claim 1, wherein the push-activated connector for receiving the thermal print head comprises a plurality of receiving connector terminals.

5. The thermal printing device of claim 4, wherein each of the plurality of receiving connector terminals comprises a receiving terminal contact.

6. The thermal printing device of claim 5, wherein each receiving terminal contact is in contact with a corresponding contact connector terminal on the thermal print head when the thermal print head is mounted.

7. The thermal printing device of claim 1, wherein the push-activated connector further comprises a tray for holding the thermal print head.

8. The thermal printing device of claim 1 further comprising:
a cover for the internal slot.

9. The thermal printing device of claim 8, wherein the cover for the internal slot is selected from the group consisting of: a slider, a cap, and a cover flap.

10. The thermal printing device of claim 1 further comprising:
a print pressure turn-knob.

11. The thermal printing device of claim 10, wherein the print pressure turn-knob has a plurality of discrete print pressure settings, each associated with different print pressures.

12. The thermal printing device of claim 11, wherein the print pressure turn-knob has three discrete print pressure settings corresponding to low, medium, and high print pressures.

13. The thermal printing device of claim 11 further comprising:
a print pressure mechanism, wherein the print pressure mechanism applies the print pressure along the surface of the thermal print head and the print pressure mechanism is controlled by the print pressure turn-knob.

14. The thermal printing device of claim 13, wherein the print pressure mechanism comprises a bracket, a spring, a leave spring, and a detent.

15. A thermal print head comprising:
a circuit board;
a plurality of heating resistor elements extending along a first long edge of the circuit board;
a plurality of contact connector terminals along one short edge of the circuit board; and
a conductor circuit pattern for establishing electrical connection between the plurality of heating resistor elements, and plurality of contact connector terminals.

16. A method for inserting a thermal print head in a thermal printing device, the method comprising:
receiving, by the thermal printing device, a thermal print head into an internal slot via an opening on a side of the housing of the thermal printing device, the slot having a push-activated connector at the end of the slot opposite the opening; and
responsive to the application of first pushing pressure on the thermal print head, mounting the thermal print head in the push-activated connector of the thermal printing device.

17. The method of claim 16, the method further comprising:
responsive to the application of second pushing pressure on the mounted thermal print head in the thermal printing device, unmounting the thermal print head from the push-activated connector in the thermal printing device; and
partially ejecting the thermal print head out of the thermal printing device so that it may easily be removed.

18. A thermal printing system comprising:
a thermal printing device comprising:
an internal slot with an opening on a side of the housing of the thermal printing device; and
a push-activated connector at the opposite end of the slot from the opening, wherein the thermal printing device is operable to:
receive, in the slot through the opening, a thermal print head with contact connector terminals on one short edge of the thermal print head; and
responsive to the application of first pushing pressure on the thermal print head, mounting the thermal print head in the push-activated connector; and
a thermal print head comprising:
a circuit board;
a plurality of heating resistor elements extending along a first long edge of the circuit board;
a plurality of contact connector terminals along one short edge of the circuit board; and
a conductor circuit pattern for establishing electrical connection between the plurality of heating resistor elements and plurality of contact connector terminals.

19. The thermal printing system of claim 18, wherein the thermal printing device is further operable to:
responsive to the application of second pushing pressure on the mounted thermal print head in the thermal printing device, unmount the thermal print head from the push-activated connector in the thermal printing device; and
partially eject the thermal print head out of the thermal printing device so that it may easily be removed.
